(19) United States
(12) Patent Application Publication
(10) Pub. No.: US 2017/0139667 A1
(43) Pub. Date: May 18, 2017

(54) AUDIO PLAY METHOD AND DEVICE

(71) Applicant: ZTE CORPORATION, Shenzhen City (CN)

(72) Inventors: Shuyan ZHANG, Shenzhen City (CN); Bo QI, Shenzhen City (CN); Bo ZHANG, Shenzhen City (CN)

(73) Assignee: ZTE CORPORATION, Shenzhen City (CN)

(21) Appl. No.: 15/319,859

(22) PCT Filed: Aug. 13, 2014
(86) PCT No.: PCT/CN2014/084313

§ 371 Date: Dec. 19, 2016

(30) Foreign Application Priority Data
Jun. 18, 2014 (CN) 201410273600.5

(51) Int. Cl. G06F 3/16

(52) U.S. Cl. CPC G06F 3/165

(57) ABSTRACT

A method and device for playing audio are provided. The method for playing audio includes the following steps: acquiring audio playing information corresponding to an audio playing instruction when the audio playing instruction is received (S10); determining whether audio data obtained after an audio file corresponding to the audio playing information is decoded is stored in a preset storage location (S20); and if yes, invoking the audio data for audio playing (S30).

### CROSS-REFERENCE TO RELATED APPLICATIONS

This application is the U.S. national phase of PCT Application No. PCT/CN2014/084313 filed on Aug. 13, 2014, which claims priority to Chinese Patent Application No. 201410273600.5 filed on Jun. 18, 2014, the disclosures of which are incorporated in their entirety by reference herein.

### TECHNICAL FIELD

The present document relates to the technical field of audio playing, and particularly, to a method and device for playing audio.

### BACKGROUND OF THE RELATED ART

At present, high power consumption of smart cell phones is a user experience problem that perplexes users. Sometimes electricity quantity of one battery will be depleted in less than a day, so the user has to charge it at home every day, which severely impacts the user experience. In addition, repetitive charging will have a strong impact on the service life of battery.

In the prior art, audio playing is one of important aspects of power consumption. For example, there are corresponding ringtones ringing when calls are coming or short messages are received, and listening to music or playing games require audio playing. However, a traditional audio playing is generally to read a corresponding audio file, then decode the audio file and perform audio playing. Because the audio file is required to be decoded whenever audio playing is performed, and massive calculation is required to be performed in the decoding process, power consumption is higher.

The above description is merely used to aid understanding of technical schemes of the present document, without admitting that the above description belongs to the prior art.

### SUMMARY

A main object of the schemes in the present document is to reduce power consumption and extend the service life of battery.

In order to achieve the above object, a method for playing audio provided by the present document includes the following steps: acquiring audio playing information corresponding to an audio playing instruction when the audio playing instruction is received; determining whether audio data obtained after an audio file corresponding to the audio playing information is decoded is stored in a preset storage location; and invoking the audio data for audio playing when the audio data obtained after the audio file corresponding to the audio playing information is decoded is stored in the preset storage location.

In an exemplary embodiment, after determining whether audio data obtained after an audio file corresponding to the audio playing information is decoded is stored in a preset storage location, the method further includes: decoding the audio file corresponding to the audio playing information, playing and storing the audio data obtained after decoding, when the audio data obtained after the audio file corresponding to the audio playing information is decoded is not stored in the preset storage location.

In an exemplary embodiment, playing and storing the audio data obtained after the decoding includes: playing the audio data obtained after the audio file is decoded; storing the audio data in the preset storage location when a number of times of playing the audio file which is currently played is greater than a preset value or when the audio file which is currently played is an audio file set by a user for storage; and adding a mapping record of the stored audio data with corresponding audio file name information in a preset mapping relation table.

In an exemplary embodiment, before storing the audio data in the preset storage location, the method further includes: making statistics of audio data meeting a preset condition among currently stored audio data when an available storage space in the preset storage location is less than a current occupation space of the audio data obtained after the decoding; and deleting the audio data meeting the preset condition and a mapping record corresponding to the audio data meeting the preset condition in the mapping relation table.

In an exemplary embodiment, deleting the audio data meeting the preset condition and a mapping record corresponding to the audio data meeting the preset condition in the mapping relation table includes: screening out audio data of which a time difference between a last playing time of the audio data and a current time is greater than a first threshold value; and deleting audio data of which a ratio of occupation space of the audio data to a corresponding number of times of playing the audio data is greater than a second threshold value and a corresponding mapping record according to a result of the screening.

In addition, in order to achieve the above object, the present document further provides a device for playing audio including: an acquisition module arranged to acquire audio playing information corresponding to an audio playing instruction when the audio playing instruction is received; a determining module arranged to determine whether audio data obtained after an audio file corresponding to the audio playing information is decoded is stored in a preset storage location; and a processing module arranged to invoke the audio data for audio playing when the audio data obtained after the audio file corresponding to the audio playing information is decoded is stored in the preset storage location.

In an exemplary embodiment, the processing module is further arranged to decode the audio file corresponding to the audio playing information, play and store the audio data obtained after the decoding, when the audio data obtained after the audio file corresponding to the audio playing information is decoded is not stored in the preset storage location.

In an exemplary embodiment, the processing module includes: a decoding unit arranged to decode the audio file corresponding to the audio playing information; a playing unit arranged to play the audio data obtained after the audio file is decoded; a storage unit arranged to store the audio data in the preset storage location when a number of times of playing the audio file which is currently played is greater than a preset value or when the audio file which is currently played is an audio file set by a user for storage; and a processing unit arranged to add a mapping record of the stored audio data with corresponding audio file name information in a preset mapping relation table.

In an exemplary embodiment, the processing module further includes: a statistics unit arranged to make statistics of audio data meeting a preset condition among currently stored audio data when an available storage space in the preset storage location is less than an occupation space of the audio data obtained after the decoding; and the processing unit is further arranged to delete the audio data meeting the preset condition and a mapping record corresponding to the audio data meeting the preset condition in the mapping relation table.

In an exemplary embodiment, the processing unit is further arranged to screen out audio data of which a time difference between a last playing time of the audio data and a current time is greater than a first threshold value, and delete audio data of which a ratio of occupation space of the audio data to a corresponding number of times of playing the audio data is greater than a second threshold value and a corresponding mapping record according to a result of the screening.

In the present document, the audio playing information corresponding to the audio playing instruction is acquired when the audio playing instruction is received; when the audio data obtained after the audio file corresponding to the audio playing information is decoded is stored in the preset storage location, the audio data obtained after the decoding is played directly; and when the audio data obtained after the audio file corresponding to the audio playing information is decoded is not stored in the preset storage location, the audio file is decoded and then played according to a traditional playing method, and then the audio data obtained after the decoding is stored in the preset storage location, such that the audio data can be directly invoked in the preset storage area to be played when the same audio file is played next time, thereby reducing decoding operations of the audio file. Therefore, the schemes of the present document may reduce power consumption and extend the service life of battery.

### BRIEF DESCRIPTION OF DRAWINGS

FIG. 1 is a flow chart of a method for playing audio according to an embodiment of the present document.

FIG. 2 is a detailed flow chart of step S50 in FIG. 1 according to an embodiment.

FIG. 3 is a detailed flow chart of step S50 in FIG. 1 according to another embodiment.

FIG. 4 is a schematic diagram of function modules of a device for playing audio according to an embodiment of the present document.

FIG. 5 is a detailed schematic diagram of function modules of a processing module in FIG. 4 according to an embodiment.

FIG. 6 is a detailed schematic diagram of function modules of the processing module in FIG. 4 according to another embodiment.

Implementation of the object, function features and advantages of the schemes of the present document will be further described in combination with the embodiments and with reference to the accompanying drawings.

### DETAILED DESCRIPTION

It should be understood that the specific embodiments described herein are only used to explain the schemes of the present document, and not to limit the protection scope of the present document.

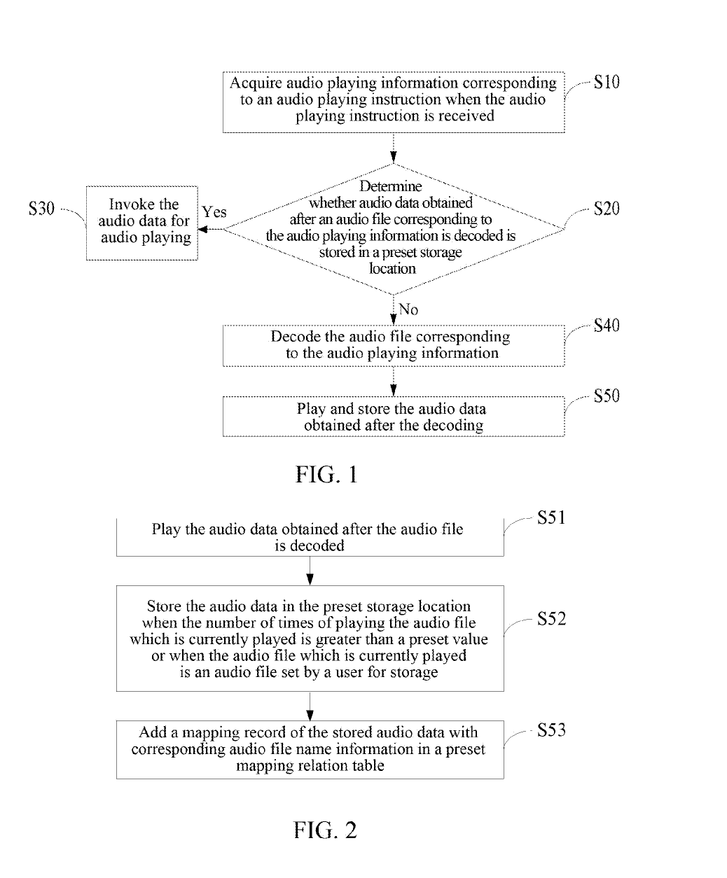

The present document provides a method for playing audio. With reference to FIG. 1, in an embodiment, the method for playing audio includes the following steps:

In step S10, when an audio playing instruction is received, audio playing information corresponding to the audio playing instruction is acquired.

The method for playing audio provided by the embodiment is mainly applied to mobile phones. The audio playing information described above is name information of an audio file which is required to be played. The name information of the audio file includes a name of the audio file and a corresponding path. When a call is coming or a user plays an audio file on a mobile phone, a player will receive an audio playing instruction sent externally. For example, an incoming call processing module will output an audio playing instruction, which includes audio playing information, when an incoming call is coming, and acquire the audio playing information in the audio playing instruction by parsing the audio playing instruction.

In step S20, whether audio data obtained after an audio file corresponding to the audio playing information is decoded is stored in a preset storage location is determined.

If yes, step S30 is executed, and if no, step S40 is executed.

In step S30, the audio data are invoked to perform audio playing.

In step S40, the audio file corresponding to the audio playing information is decoded.

In step S50, the audio data obtained after the decoding are played and stored.

In the embodiment, the audio data obtained after the audio file is decoded may be set to be stored in the preset storage location. For example, when an audio file 1 is played for the first time, the audio file is decoded, the audio data obtained after the decoding is played, and the audio data obtained after the decoding can also be stored in the preset storage location described above after the decoding is completed. When the audio file is played again, audio playing can be implemented by directly invoking the audio data stored in the preset storage location. Particularly, the preset storage location can be in a built-in SD card or an external SD card in a storage space in a mobile phone.

In the present document, the audio playing information corresponding to the audio playing instruction is acquired when the audio playing instruction is received; when the audio data obtained after the audio file corresponding to the audio playing information is decoded is stored in the preset storage location, the audio data obtained after the decoding is played directly; and when the audio data obtained after the audio file corresponding to the audio playing information is decoded is not stored in the preset storage location, the audio file is decoded and then played according to a traditional playing method, and then the audio data obtained after the decoding is stored in the preset storage location, such that the audio data can be directly invoked in the preset storage area to be played when the same audio file is played next time, thereby reducing decoding operations of the audio file. Therefore, the schemes of the present document may reduce power consumption and extend the service life of battery.

Further, with reference to FIG. 2, based on the embodiment described above, in an embodiment, the step S50 described above includes the following steps:

In step S51, the audio data obtained after the audio file is decoded is played.

In step S52, when the number of times of playing the audio file which is currently played is greater than a preset value or when the audio file which is currently played is an audio file set by a user for storage, the audio data is stored in the preset storage location.

In step S53, a mapping record of the stored audio data with corresponding audio file name information is added in a preset mapping relation table.

It can be understood that contents of the mapping relation table described above may be set according to actual requirements. In an exemplary embodiment, the mapping relation table described above includes: audio file name information, file name information corresponding to the audio data, the number of times of playing the audio data, the occupation space of the audio data and the most recent playing time.

In particular, when the audio data obtained after the audio file corresponding to the audio file name information is decoded is not stored in the preset storage location, the corresponding audio file will be acquired according to the audio file name information, and a decoding program and a decoding monitoring program are started, such that the audio file can be decoded by the decoding program. After the decoding monitoring program monitors that the decoding of the audio file is completed, the audio data obtained after the decoding will be extracted to implement audio playing, and a storage program is invoked to store the audio data in the preset storage location to form a new file. File name information of the new file is the file name information corresponding to the audio data, and includes a file name of the new file and a corresponding path. After the audio data is stored in the preset storage location, a mapping record is added in the preset mapping relation table, such that a one-to-one mapping relation is formed between the audio file name information and the file name information corresponding to the audio data. Whether the audio data obtained after the audio file corresponding to the audio file name information is decoded is stored in the preset storage location can be determined by looking up whether a mapping record corresponding to the audio file name information exists in the mapping relation table. It should be noted that the number of times of playing the audio data described above is used for recording the number of times of playing the audio data through directly invoking the preset storage location, and in particular, the number of times of playing a corresponding audio data can be modified after the audio data is invoked for audio playing. The audio file set by the user for storage as described above is an audio file, such as various short messages and the like, which is designated by the user to be stored in the preset storage location after the audio file is decoded. Since the audio file set by the user for storage is set, the pertinence for storage of the audio data obtained after the audio file is decoded is improved.

Further, with reference to FIG. 3, based on the embodiment described above, in an embodiment, before execution of the step S52 described above, the following steps are further included:

In step S54, when an available storage space in the preset storage location is less than an occupation space of the audio data obtained after decoding, statistics of audio data meeting a preset condition among currently stored audio data is made.

In step S55, the audio data meeting the preset condition and a mapping record corresponding to the audio data meeting the preset condition in the mapping relation table are deleted.

In the embodiment, a size of the storage space in the preset storage location can be set by the user to be 3G or 5G and the like, for example. When new audio data is stored, whether there is enough storage space in the preset storage location is determined by comparing the available storage space in the preset storage location with the occupation space of the audio data obtained after the decoding. When the available storage space in the preset storage location is greater than or equal to the occupation space of the audio data obtained after the decoding, it means that there is enough storage space in the preset storage location. When the available storage space in the preset storage location is less than the occupation space of the audio data obtained after the decoding, it means that there is not enough storage space in the preset storage location, and at this time, the audio data meeting the preset condition in the preset storage location is deleted, and the corresponding mapping record is deleted in the mapping relation table at the same time.

It can be understood that the preset condition described above may be set according to actual requirements. In an exemplary embodiment, the preset condition described above is that the time difference between the last playing time (i.e., the most recent playing time in the mapping record described above) of the audio data and the current time is greater than a first threshold value and a ratio of the occupation space of the audio data to a corresponding number of times of playing the audio data is greater than a second threshold value. In particular, the step S55 described above includes: screening out audio data of which the time difference between the last playing time of the audio data and the current time is greater than the first threshold value; and deleting the audio data of which the ratio of the occupation space of the audio data to the corresponding number of times of playing the audio data is greater than the second threshold value and a corresponding mapping record according to the screening result. In the embodiment, since the audio data of which the time difference between the last playing time and the current time is greater than the first threshold value and of which the ratio of the occupation space to the corresponding number of times of playing is greater than the second threshold value is deleted, the preset storage location can be optimized, which is beneficial for improving a system operating speed and the storage of new audio data.

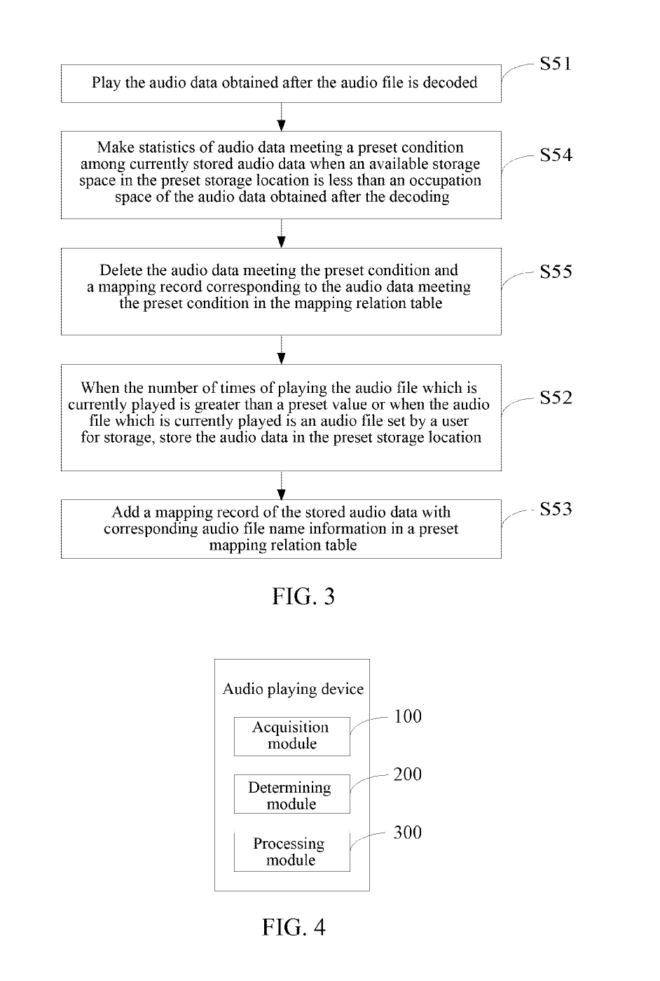

The present document also provides a device for playing audio. With reference to FIG. 4, in an embodiment, the device for playing audio provided by the present document includes the following modules.

An acquisition module 100 is arranged to acquire audio playing information corresponding to an audio playing instruction when the audio playing instruction is received.

The method for playing audio provided by the embodiment is mainly applied to mobile phones. The audio playing information described above is name information of an audio file which is required to be played. The name information of the audio file includes a name of the audio file and a corresponding path. When a call is coming or a user plays an audio file on a mobile phone, a player will receive an audio playing instruction sent externally. For example, an incoming call processing module will output an audio playing instruction, which includes audio playing information, when an incoming call is coming, and acquire the audio playing information in the audio playing instruction by parsing the audio playing instruction.

A determining module 200 is arranged to determine whether audio data obtained after an audio file corresponding to the audio playing information is decoded is stored in a preset storage location.

A processing module 300 is arranged to invoke the audio data for audio playing when the audio data obtained after the audio file corresponding to the audio playing information is decoded is stored in the preset storage location; and decode the audio file corresponding to the audio playing information, play and store the audio data obtained after the decoding when the audio data obtained after the audio file corresponding to the audio playing information is decoded is not stored in the preset storage location.

In the embodiment, the audio data obtained after the audio file is decoded may be set to be stored in the preset storage location. For example, when an audio file 1 is played for the first time, the audio file is decoded, the audio data obtained after the decoding is played, and the audio data obtained after the decoding can also be stored in the preset storage location described above after the decoding is completed. When the audio file is played again, audio playing can be implemented by directly invoking the audio data stored in the preset storage location. Particularly, the preset storage location can be in a built-in SD card or an external SD card in a storage space in a mobile phone.

In the present document, the audio playing information corresponding to the audio playing instruction is acquired when the audio playing instruction is received; when the audio data obtained after the audio file corresponding to the audio playing information is decoded is stored in the preset storage location, the audio data obtained after the decoding is played directly; and when the audio data obtained after the audio file corresponding to the audio playing information is decoded is not stored in the preset storage location, the audio file is decoded and then played according to a traditional playing method, and then the audio data obtained after the decoding is stored in the preset storage location, such that the audio data can be directly invoked in the preset storage area to be played when the same audio file is played next time, thereby reducing decoding operations of the audio file. Therefore, the schemes of the present document may reduce power consumption and extend the service life of battery.

Further, with reference to FIG. 5, based on the embodiment described above, in an embodiment, the processing module 300 described above includes the following units.

A decoding unit 301 is arranged to decode the audio file corresponding to the audio playing information.

A playing unit 302 is arranged to play the audio data obtained after the audio file is decoded.

A storage unit 303 is arranged to store the audio data in the preset storage location when the number of times of playing the audio file which is currently played is greater than a preset value or when the audio file which is currently played is an audio file set by a user for storage.

A processing unit 304 is arranged to add a mapping record of the stored audio data with corresponding audio file name information in a preset mapping relation table.

It can be understood that contents of the mapping relation table described above may be set according to actual requirements. In an exemplary embodiment, the mapping relation table described above includes: audio file name information, file name information corresponding to the audio data, the number of times of playing the audio data, the occupation space of the audio data and the most recent playing time.

In particular, when the audio data obtained after the audio file corresponding to the audio file name information is decoded is not stored in the preset storage location, the corresponding audio file will be acquired according to the audio file name information, and a decoding program and a decoding monitoring program are started by the decoding unit 301, such that the audio file can be decoded by the decoding program. After the decoding monitoring program monitors that the decoding of the audio file is completed, the audio data obtained after the decoding will be extracted by the paying unit 302 to implement audio playing, and a storage program is invoked by the storing unit 303 to store the audio data in the preset storage location to form a new file. File name information of the new file is the file name information corresponding to the audio data, and includes a file name of the new file and a corresponding path. After the audio data is stored in the preset storage location, a mapping record is added by the processing unit 304 in the preset mapping relation table, such that a one-to-one mapping relation is formed between the audio file name information and the file name information corresponding to the audio data. Whether the audio data obtained after the audio file corresponding to the audio file name information is decoded is stored in the preset storage location can be determined by looking up whether a mapping record corresponding to the audio file name information exists in the mapping relation table. It should be noted that the number of times of playing the audio data described above is used for recording the number of times of playing the audio data through directly invoking the preset storage location, and in particular, the number of times of playing a corresponding audio data can be modified after the audio data is invoked for audio playing. The audio file set by the user for storage as described above is an audio file, such as various short messages and the like, which is designated by the user to be stored in the preset storage location after the audio file is decoded. Since the audio file set by the user for storage is set, the pertinence for storage of the audio data obtained after the audio file is decoded is improved.

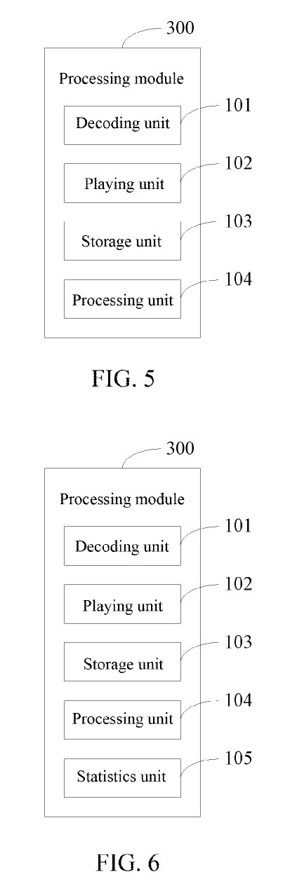

Further, with reference to FIG. 6, based on the embodiment described above, in an embodiment, the processing module 300 described above further includes a statistics unit 305 arranged to make statistics of audio data meeting a preset condition among currently stored audio data when an available storage space in the preset storage location is less than an occupation space of the audio data obtained after the decoding.

The processing unit 304 is further arranged to delete the audio data meeting the preset condition and a mapping record corresponding to the audio data meeting the preset condition in the mapping relation table.

In the embodiment, a size of the storage space in the preset storage location can be set by the user to be 3G or 5G and the like, for example. When new audio data is stored, whether there is enough storage space in the preset storage location is determined by comparing the available storage space in the preset storage location with the occupation space of the audio data obtained after the decoding. When the available storage space in the preset storage location is greater than or equal to the occupation space of the audio data obtained after the decoding, it means that there is enough storage space in the preset storage location. When the available storage space in the preset storage location is less than the occupation space of the audio data obtained after the decoding, it means that there is not enough storage space in the preset storage location, and at this time, the audio data meeting the preset condition in the preset storage location is deleted, and the corresponding mapping record is deleted in the mapping relation table at the same time.

It can be understood that the preset condition described above may be set according to actual requirements. In an exemplary embodiment, the preset condition described above is that the time difference between the last playing time of the audio data and the current time is greater than a first threshold value and a ratio of the occupation space of the audio data to a corresponding number of times of playing the audio data is greater than a second threshold value. In particular, the processing unit 304 described above is arranged to screen out audio data of which the time difference between the last playing time (i.e., the most recent playing time in the mapping record described above) and the current time is greater than the first threshold value, and delete audio data of which the ratio of the occupation space of the audio data to the corresponding number of times of playing the audio data is greater than the second threshold value and a corresponding mapping record according to the screening result. In the embodiment, since the audio data of which the time difference between the last playing time and the current time is greater than the first threshold value and of which the ratio of the occupation space to the corresponding number of times of playing is greater than the second threshold value is deleted, the preset storage location can be optimized, which is beneficial for improving the system operating speed and the storage of new audio data.

The above description is merely exemplary embodiments of the present document, and is not intended to limit the protection scope of the document. Equivalent structures or equivalent flow transformations made based on contents of the specification and accompanying drawings of the present document or applied directly or indirectly in other related technical fields are all included in the protection scope of the present document likewise.

### INDUSTRIAL APPLICABILITY

As mentioned above, through the examples and exemplary embodiments described above, the audio data can be directly invoked in the preset storage area to be played, thereby reducing decoding operations of the audio file. Therefore, the schemes of the present document may reduce power consumption and extend the service life of battery.

1. A method for playing audio, comprising:
acquiring audio playing information corresponding to an audio playing instruction when the audio playing instruction is received;
determining whether audio data obtained after an audio file corresponding to the audio playing information is decoded is stored in a preset storage location; and
invoking the audio data for audio playing when the audio data obtained after the audio file corresponding to the audio playing information is decoded is stored in the preset storage location.

2. The method according to claim 1, wherein after determining whether audio data obtained after an audio file corresponding to the audio playing information is decoded is stored in a preset storage location, the method further comprises:
decoding the audio file corresponding to the audio playing information, playing and storing the audio data obtained after the decoding, when the audio data obtained after the audio file corresponding to the audio playing information is decoded is not stored in the preset storage location.

3. The method according to claim 2, wherein playing and storing the audio data obtained after the decoding comprises:
playing the audio data obtained after the audio file corresponding to the audio playing information is decoded;
storing the audio data in the preset storage location when a number of times of playing the audio file which is currently played is greater than a preset value or when the audio file which is currently played is an audio file set by a user for storage; and
adding a mapping record of the stored audio data with corresponding audio file name information in a preset mapping relation table.

4. The method according to claim 3, wherein before storing the audio data in the preset storage location, the method further comprises:
making statistics of audio data meeting a preset condition among currently stored audio data when an available storage space in the preset storage location is less than a current occupation space of the audio data obtained after the decoding; and
deleting the audio data meeting the preset condition and a mapping record corresponding to the audio data meeting the preset condition in the mapping relation table.

5. The method according to claim 4, wherein deleting the audio data meeting the preset condition and a mapping record corresponding to the audio data meeting the preset condition in the mapping relation table comprises:
screening out audio data of which a time difference between a last playing time of the audio data and a current time is greater than a first threshold value; and
deleting audio data of which a ratio of occupation space of the audio data to a corresponding number of times of playing the audio data is greater than a second threshold value and a corresponding mapping record according to a result of the screening.

6. A device for playing audio, comprising:
an acquisition module, arranged to acquire audio playing information corresponding to an audio playing instruction when the audio playing instruction is received;
a determining module, arranged to determine whether audio data obtained after an audio file corresponding to the audio playing information is decoded is stored in a preset storage location; and
a processing module, arranged to invoke the audio data for audio playing when the audio data obtained after the audio file corresponding to the audio playing information is decoded is stored in the preset storage location.

7. The device according to claim 6, wherein the processing module is further arranged to decode the audio file corresponding to the audio playing information, play and store the audio data obtained after the decoding, when the audio data obtained after the audio file corresponding to the audio playing information is decoded is not stored in the preset storage location.

8. The device according to claim 7, wherein the processing module comprises:
a decoding unit, arranged to decode the audio file corresponding to the audio playing information;
a playing unit, arranged to play the audio data obtained after the audio file is decoded;
a storage unit, arranged to store the audio data in the preset storage location when a number of times of playing the audio file which is currently played is greater than a preset value or when the audio file which is currently played is an audio file set by a user for storage; and
a processing unit, arranged to add a mapping record of the stored audio data with corresponding audio file name information in a preset mapping relation table.

9. The device according to claim 8, wherein the processing module further comprises:
a statistics unit, arranged to make statistics of audio data meeting a preset condition among currently stored audio data when an available storage space in the preset storage location is less than an occupation space of the audio data obtained after the decoding; and
the processing unit is further arranged to delete the audio data meeting the preset condition and a mapping record corresponding to the audio data meeting the preset condition in the mapping relation table.

10. The device according to claim 9, wherein the processing unit is further arranged to screen out audio data of which a time difference between a last playing time of the audio data and a current time is greater than a first threshold value, and delete audio data of which a ratio of occupation space of the audio data to a corresponding number of times of playing the audio data is greater than a second threshold value and a corresponding mapping record according to a result of the screening.
